(19) United States
(12) Patent Application Publication
(10) Pub. No.: US 2026/0093569 A1
(43) Pub. Date: Apr. 2, 2026

(54) STORAGE DEVICE AND METHODS OF OPERATION

(71) Applicant: SK hynix Inc., Icheon-si (KR)

(72) Inventor: Hee Chang KIM, Icheon-si (KR)

(21) Appl. No.: 19/084,345

(22) Filed: Mar. 19, 2025

(30) Foreign Application Priority Data
Sep. 30, 2024 (KR) 10-2024-0132870

(51) Int. Cl. G06F 11/07; G06F 13/16

(52) U.S. Cl. CPC G06F 11/0727; G06F 11/0781; G06F 13/1668

(57) ABSTRACT

An operation method of a storage device comprises, determining an importance level of data to read in memory, performing, for data with high importance, a first level read operation configured to perform a read operation and/or a read recovery operation, and obtain data with no error or determine that read is failed when not obtaining data with no error and performing, for data with low importance, a second level read operation configured to perform a read operation and/or a read recovery operation and terminate a read recovery operation when a preset termination condition is satisfied.

### CROSS-REFERENCE TO RELATED APPLICATION

This application claims priority under 35 U.S.C. § 119(a) to Korean Patent Application No. 10-2024-0132870, filed on Sep. 30, 2024 in the Korean Intellectual Property Office, the disclosure of which is incorporated herein by reference in its entirety.

### FIELD

Embodiments of the present disclosure relate to a storage device and an operation method thereof, more particularly, a method for improving read performance for memory.

### BACKGROUND

A storage device is a device that can store data based on a request from an external device such as a computer, a mobile terminal (e.g., smartphone and a tablet) or various other electronic devices.

Such a storage device may include a memory and a memory controller configured to control the memory. The memory controller may receive a command from an external device and execute or control operations to read data from the memory, write/program data to the memory or erase data from the memory based on the received command.

The storage device may recover a failed read by hard decoding and/or soft decoding when a read operation fails during the read.

Hard decoding has a low recovery cost and can perform recovery quickly but the recovery probability is relatively low. Soft decoding has a high recovery cost and a slow recovery speed, but recovery probability is relatively high. To use these advantages of the hard decoding and soft decoding and to perform read recovery efficiently, a read recovery algorithm may be implemented to perform hard decoding first and then perform soft decoding if the hard decoding fails.

However, if such a recovery algorithm is implemented in this way, it may take a considerable amount of time to complete the recovery and accordingly, not only the read operation in question, but also following read operations may have significant latency, which may degrade system performance.

### SUMMARY

Accordingly, one object of the present disclosure is to solve the above-noted disadvantages of the prior art, and to provide an operation method of a storage device that may reduce the average read time by implementing a read recovery algorithm applied based on the importance of data to be read.

Aspects according to the present disclosure are not limited to the above, and other aspects and advantages that are not mentioned above can be clearly understood from the following description and can be more clearly understood from the embodiments set forth herein.

According to embodiments of the present disclosure, to solve the objects of the present disclosure, a memory controller may include a first interface (e.g., a host interface) configured to perform data communication with a first external device (e.g., a host or an external device), a second interface (e.g., a memory interface) configured to generate a signal configured to control an operation of a second external device (e.g., a memory) and at least one processor configured to determine an importance level of data to be read from the external device, perform preset read recovery operations when a read operation fails, and perform a first level read operation to recover data to be read with a high importance and perform a second level read operation to recover the data to be read with a low importance, wherein the first level read operation terminates when high importance data to be read is obtained without errors or when the data to be read is determined as uncorrectable, and the second level read operation terminates when a preset termination condition is satisfied for low importance data.

In the first level read operation, a first read recover operation is performed when a first read operation fails to obtain the high importance data to be read without an error and terminates when the preset read recovery operations have been performed and fail to obtain the high importance data without an error, and in the second level read operation, a second read recovery operation is performed when a second read operation fails to obtain the low importance data to be read without an error and terminates when the preset termination condition is satisfied or when the preset read recovery operations obtain the low importance data without an error.

The at least one processor may be configured to set, as the first read recovery operation, at least one hard-decoding-based read recovery operation and at least one soft-decoding-based read recovery operation as the preset read recovery operations.

The at least one processor may be configured to set, for the second read recovery operation, one or more preset read recovery operations that are set for the first read recovery operation and set, as the termination condition of the second read recovery operation, performance of the preset read recovery operations.

The at least one processor may be configured set for the second read recovery operation to include the at least one hard-decoding-based read recovery operation as the preset read recovery operations and set, as the preset termination condition of the second read recovery operation, performance of the preset read recovery operations.

The at least one processor may be configured to set as the termination condition of the second read recovery operation a bit error rate of the low importance data at a preset value or less.

The at least one processor may be configured to set a read recovery operation set the preset read recovery operations of the second read recovery operation to be the same as the preset read recovery operations of the first read recovery operation set in the first read recovery operation.

The at least one processor may be configured to receive a read command for composite data comprising a first bit unit including bits with high importance and a second bit unit including bits with low importance from the first external device through the first interface, perform the first level read operation to read the first bit unit of the composite data from the second external device through the second interface, perform the second level read operation to read the second bit unit of the composite data from the second external device through the second interface and transmit a read failure message, requested composite data with no error or composite data with error to the first external device based on whether the first level read operation read for the first bit unit is successful and whether the second level read operation read for the second bit unit is successful.

The at least one processor may be configured to transmit the read failure message to the first external device when the first level read operation read for the first bit unit is failed, transmit composite data of the first bit unit and the second bit unit with no errors, when both the first level read operation for the first bit unit and the second level read operation for the second bit unit are successful and transmit composite data of the first bit unit with no error and the second bit unit with an error, when the first level read operation for the first bit unit is successful and the second level read operation for the second bit unit is failed.

The at least one processor may be configured to receive a write command for the composite data from the first external device, write the first bit unit of the composite data in a first memory block of the second external device and write the second bit unit of the composite data in a second memory block of the second external device.

The at least one processor is configured to receive the write command including information about bits corresponding to the first bit unit and the second bit unit from the first external device and distinguish and extract the first bit unit and the second bit unit based on the information about bits corresponding to the first bit unit and the second bit unit.

The at least one processor may be configured preset information about bits corresponding to the first bit unit and bits corresponding to the second bit unit and distinguish and extract the first bit unit and the second bit unit based on the preset information.

The first memory block and a type of the second memory block may have different types.

The at least one processor may be configured to receive a read command for the first bit unit from the first external device, transmit the read failure message to the first external device when the first level read operation for the first bit unit is failed and transmit the first bit unit to the first external device when the first level read operation for the first bit unit is successful.

The at least one processor may be configured to transmit composite data of only the first bit unit, when the first level read operation for the first bit unit is successful and the second level read operation for the second bit unit is failed.

The at least one processor may be configured to receive a read command for a first data block with high importance data and a second data block with low importance data from the first external device, perform the first level read operation to read the first data block from the second external device, perform the second level read operation to read the second data block from the second external device and transmit a read failure message, data with no error or data with error to the first external device based on whether the first level read operation for the first data block is successful and the second level read operation for the second data block is successful.

The at least one processor may be configured to transmit the read failure message to the first external device when the first level read operation for the first data block fails, transmit data with no error including the first data block with no errors and the second data block with no errors to the first external device when both the first level read operation for the first data block and the second level read operation for the second data block are successful and transmit data with error including the first data block with no errors and the second data block with an error when the first level read operation for the first data block is successful and the second level read operation for the second data block is failed.

The at least one processor may be configured receive a write command for the data from the first external device, write the first data block of the data in a first memory block of the second external device and write the second data block of the data in a second memory block of the second external device.

The at least one processor may be configured to receive the write command including importance information about the first data block and the second data block from the first external device, and to distinguish extract the first data block and the second data block based on the importance information about the first data block and the second data block.

The at least one processor may be configured to determine a frequency of a read operation for data that is read during a background operation and for the data that is read during the background operation, set a low importance level when the frequency of the read operation is a preset value or less and set a high importance level when the frequency of the read operation is more than the preset value.

According to embodiments of the present disclosure, an operation of a memory controller may include determining an importance level of level 1 or level 2 for data to read from a memory, performing, for data with importance level 1, a first level read operation configured to obtain data with no errors or determine that data without errors cannot be obtained by a first read recovery operation and performing, for data with importance level 2, a second level read operation configured to and terminate a second read recovery operation when a preset termination condition is satisfied.

According to embodiments of the present disclosure, a storage device may include a memory configured to store data and a memory controller configured to receive a command from a first external device and control an operation of the memory based on the received command. The memory controller may include a first interface configured to perform data communication with the first external device; a second interface configured to generate signal configured to control an operation of the memory and at least one processor configured to determine an importance level of data to be read from the memory, perform, for data with importance level 1, a first level read operation including a read operation and a read recovery operation and configured to obtain data with no errors or determine that the read operation is failed when data without errors cannot be obtained and perform, for data with importance level 2, a second level read operation including a read operation and a read recovery operation and configured to terminate a read recovery operation when a preset termination condition is satisfied.

According to the embodiments of the present disclosure, read performance may be prioritized over data accuracy, thereby preventing overall read performance deterioration for data with low importance.

Furthermore, according to the embodiments of the present disclosure, the host read speed may be improved, thereby improving the host operation performance.

### BRIEF DESCRIPTION OF THE DRAWINGS

FIG. 1 is a schematic view of a storage device according to various embodiments of the present disclosure;

FIG. 2 is a block view schematically illustrating a memory according to embodiments of the present disclosure;

FIG. 3 is a view schematically illustrating a memory block of a memory according to embodiments of the present disclosure;

FIG. 4 describes a read recovery operation of a storage device according to an embodiment of the present disclosure;

FIG. 5 is a flow chart illustrating an operation method of data reading according to one embodiment of the present disclosure;

FIG. 6 is a view illustrating a second level read operation according to an embodiment of the present disclosure;

FIG. 7 is a view illustrating a first embodiment of performing a method of reading data based on importance according to embodiments of the disclosure;

FIG. 8 is a view illustrating various examples that express real numbers on a computer;

FIG. 9 is a view illustrating an example of storing data in different physical block addresses based on importance;

FIG. 10 is a view illustrating an example of reading data stored in different physical block addresses based on importance;

FIG. 11 is a view illustrating an example of storing data in different memory blocks based on importance according to various embodiments of the present disclosure; and

FIG. 12 is a view illustrating an example of reading data stored in different memory blocks based on importance according to various embodiments of the present disclosure.

### DETAILED DESCRIPTION

Hereinafter, description will now be given in detail according to exemplary embodiments disclosed herein, with reference to the accompanying drawings.

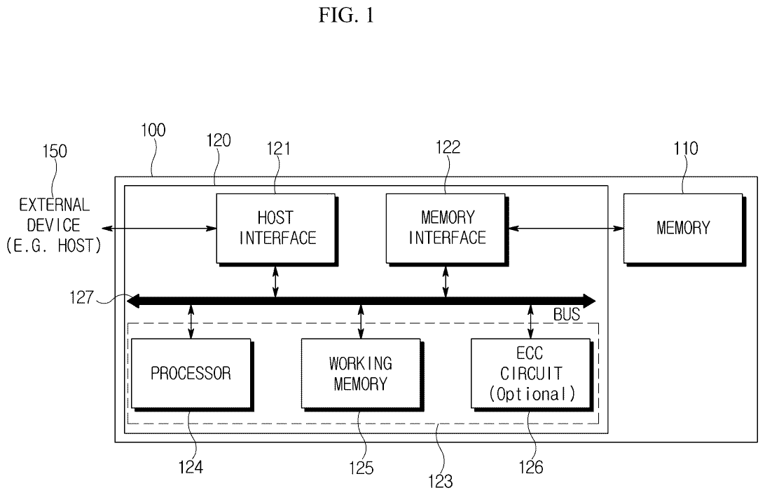

FIG. 1 is a schematic view of a storage device 100 according to various embodiments of the present disclosure.

Referring to FIG. 1, a storage device 100 according to embodiments of the present disclosure may include a memory 110 configured to store data and a controller 120 configured to control the memory 110. If necessary, additional components may be provided in the storage device 100.

The memory 110 may operate in response to the control of the controller 120. For example, operations of the memory 110 may include read operations, program operations (i.e., write operations) and erasure operations.

For example, the memory 110 may be a nonvolatile memory of various structures or types such as NAND Flash Memory, 3D NAND Flash Memory, NOR Flash Memory, Resistive Random Access Memory (RRAM), Phase-Change Memory (PRAM), Magnetoresistive Random Access Memory (MRAM), Ferroelectric Random Access Memory (FRAM), or Spin Transfer Torque Random Access Memory (STT-RAM).

The memory 110 may be implemented as a three-dimensional array structure. Embodiments of the present disclosure may be applied, not only to a flash memory in which a charge storage layer is configured with a conductive floating gate, but also to a charge trap flash (CTF) in which a charge storage layer is configured with an insulating film.

The memory 110 may receive a command and an address, etc. from the controller 120 (which may be also referred to as the memory controller) and may access an area selected by an address from the memory cell array. That is, the memory 110 may execute an operation indicated for an area selected by the address based on the command.

For example, the memory 110 may perform a program operation, a read operation and an erasure operation. When performing a program operation, the memory 110 may program data in the area selected by the address. When performing a read operation, the memory 110 may read data from the area selected by the address. When performing an erasure operation, the memory 110 may erase data stored in the area selected by the address.

The controller 120 may control program, read, erasure and background operations for the memory 110. Here, a background operation may include one or more of garbage collection (GC), wear leveling (WL), read reclaim (RR) or bad block management (BBM).

The controller 120 may control the operation of the memory 110 based on a request from an external device (e.g., HOST) 150 located outside the storage device 100, or, the controller 120 may control the operation of the memory 110 for normal management regardless of a request from the external device 150.

The external device 150 may be a storage device configured of UMPC (Ultra Mobile PC), workstation, PDA (Personal Digital Assistants), tablet, mobile phone, smart phone, e-book, PMP (portable multimedia player), portable game console, navigation device, black box, digital camera, DMB (Digital Multimedia Broadcasting) player, smart television, digital audio recorder, digital audio player, digital picture recorder, digital picture player, digital video recorder, digital video player and a data center, one of various electronic devices configured of a home network, one of various electronic devices configured of a computer network, one of various electronic devices configured of a telematics network, an RFID (i.e., Radio Frequency Identification) device, a mobile device (e.g., a vehicle, a robot and a drone) that drives under human control or autonomously on the ground, water or air, etc.

The external device 150 may include at least one operating system (OS). An operating system may manage and control the overall functions and operations of the external device, and may provide interaction between the external device 150 and the storage device 100. Operating systems may be divided into general operating systems and mobile operating systems, depending on the mobility of external device.

Meanwhile, the controller 120 and the external device 150 may be separate devices. In some cases, the controller 120 and the external device 150 may be implemented as one integrated device. Below, for convenience of description, examples where the controller 120 and the external device 150 are separate devices will be described.

Referring to FIG. 1, the controller 120 may include a host interface 121, a memory interface 122 and a control circuit 123.

The host interface 121 may provide an interface for communication with the external device. For example, the host interface 121 may provide an interface configured to use at least one of various interface protocols such as a USB (Universal Serial Bus) protocol, an MMC (multimedia card) protocol, a PCI (peripheral component interconnection) protocol, a PCI-E (PCI-express) protocol, an ATA (Advanced Technology Attachment) protocol, a Serial-ATA protocol, a Parallel-ATA protocol, a SCSI (small computer small interface) protocol, an ESDI (enhanced small disk interface) protocol, an IDE (Integrated Drive Electronics) protocol, an SMBus (system management bus) protocol, an I2C (inter-integrated circuit) protocol, an I3C (improved inter-integrated circuit) protocol, a proprietary protocol, etc.

The control circuit 123 may receive a command from the host interface 121, and perform an operation of treating the received command,

The memory interface 122 may be connected to the memory 110 and configured to provide an interface for communication with the memory 110. That is, the memory interface 122 may be configured to provide an interface between the memory 110 and the controller 120 in response to the control of the control circuit 123.

The control circuit 123 may control the operation of the memory 110 by performing overall control operations of the controller. To this end, according to embodiments of the disclosure, the control circuit 123 may include a processor 124, a working memory 125 and an optional error detection and correction circuit (ECC Circuit) 126.

### The Processor 124 May Control All Operations of the Controller 120.

The processor 124 may be configured to communicate with the external device via the host interface 121 and to communicate with the memory 110 via the memory interface 122.

The processor 124 may perform the function of a flash translation layer (FTL). The processor 124 may convert a logical block address (LBA) provided by an external device into a physical block address (PBA) through a flash translation layer (FTL). The flash translation layer may receive an input of a logical block address and use a mapping table to convert it into a physical block address.

There are several address mapping methods of the flash translation layer, depending on the mapping unit. Typical address mapping methods include a page mapping method, a block mapping method and a hybrid mapping method.

The processor 124 may randomize data received from the external device. For example, the processor 124 may randomize the data received from the external device by using a preset randomizing seed. The randomized data may be provided to the memory 110 and programmed into the memory 110.

The processor 124 may de-randomize data received from the memory 110 when performing a read operation. For example, the processor 124 may de-randomize data received from the memory 110 by using a de-randomizing seed. The de-randomized data may be output to the external device.

The processor 124 may also perform a background function for the memory 110 such as a garbage collection (GC) function, a wear leveling (WL) function and a bad block management function.

The garbage collection function may be a function that collects data partially written in an existing memory block and moves that data to another memory block to record it, in order to free space in the memory 110 for recording data when there is not enough space.

The wear leveling function may be a function that prevents excessive use or too little use of a specific block by recording data in all memory blocks of the memory 110 in an even or distributed manner, so as to prevent errors and data loss in the memory 110 and to improve the durability and stability of product.

The bad block management function may be a function that detects a bad block in the memory 110 and, if there is a spare block, replaces the bad block with a spare block to prevent data from being written to the bad block.

The processor 124 may control the operation of the controller 120 by executing firmware. In other words, the processor 124 may control overall operations of the controller 120 and execute (i.e., drive) firmware stored in the working memory 125 at booting time. Hereinafter, the operation of the storage device 100 described in embodiments of the present disclosure may be implemented in a method in which the processor 124 executes firmware in which the corresponding operation is defined.

Firmware is a program executed in the storage device 100 to drive the storage device 100, and may include various functional layers. For example, firmware may include binary data in which codes for executing the functional layers mentioned above, respectively, are defined.

For example, the firmware may include a flash translation layer configured to perform a conversion function between a logical block address transmitted from an external device to the storage device 100 and a physical block address of the memory 110; a host interface layer (HIL) configured to interpret a command received from an external device through the host interface 121 and transmit it to the flash translation layer; and a flash interface layer (FIL) configured to transmit a command instructed by the flash translation layer to the memory 110.

In addition, the firmware may include a garbage collection function, a wear leveling function, a bad block management function and etc.

Such the firmware may be loaded into the working memory 125 from the memory 110 or a separate non-volatile memory (e.g., ROM, NOR Flash) located outside the memory, for example. The processor 124 may first load all or part of the firmware into the working memory 125, when it executes a boot operation after power is applied.

The processor 124 may perform logical operations defined in the firmware loaded in the working memory 125 to control the overall operations of the controller 120. The processor 124 may store the result of the logical operations defined in the firmware in the working memory 125. The processor 124 may control the controller 120 to create a command or signal based on the result of the logical operation defined in the firmware. The processor 124 may generate an event (e.g., an interrupt) for loading the corresponding portion of the firmware, unless the portion of the firmware in which the logical operation to be performed is defined is loaded in the working memory 125.

The processor 124 may load meta data required to drive the firmware in the memory 110. Meta data may be data for managing the memory 110 and may include management information for user data stored in the memory 110.

The firmware may may be updated while the storage device 100 is being manufactured or driven. The controller 120 may download a new firmware from outside the storage device 100 and update the existing firmware with the new firmware.

The working memory 125 may store a firmware, a program code, a command or data required to operate the controller 120. Such the working memory 125 may include one or more of Static RAM (SRAM), Dynamic RAM and Synchronous DRAM (SDRAM) as a volatile memory, for example.

The error detection and correction circuit 126 may detect an error bit of target data, using an error correction code, and may correct the detected error bit. Here, target data may be data stored in the working memory 125 or data read from the memory 110, for example.

The error detection and correction circuit 126 may be implemented to decode data with an error correction code. The error detection and correction circuit 126 may be implemented as various decoders. According to one embodiment, the error detection and correction circuit 126 may be implemented as a Low Density Parity Check (LDPC) decoder.

For example, the error detection and correction circuit 126 may detect an error bit in a sector unit set for each read data. That is, each read data may be composed of multiple sectors. A sector means a smaller data unit than a page, which is a read unit of a flash memory. The sectors in the sector unit set for each read data may correspond to each other through addresses.

The error detection and correction circuit 126 may calculate the bit error rate (BER) and determine whether correction is possible on a sector unit basis. For example, when the bit error rate (BER) is higher than a preset reference value, it may be determined that the corresponding sector is uncorrectable or failed. On the other hand, when the bit error rate (BER) is lower than the reference value, it may be determined that the corresponding sector is correctable or passed.

The error detection and correction circuit 126 may sequentially perform error detection and correction operations on all read data. The error detection and correction circuit 126 may omit error detection and correction operations for a sector included in the next read data, if the sector provided in the read data is correctable. When the error detection and correction operation for all read data is completed in this way, the error detection and correction circuit 126 may detect a sector judged as uncorrectable towards the end of the operation. There may be one or more sectors determined to be uncorrectable. The error detection and correction circuit 126 may transmit information (e.g., address information) about the sector determined to be uncorrectable to the processor 124.

The error detection and correction circuit 126 may perform encoding on original data to be acquired from the external device 150 and stored in the memory 110 for error detection and correction, so as to generate encoded data, including parity data, for error correction. The generated encoding data may be stored in the memory 110 together with the original data based on the control of the memory interface 122.

The bus 127 may be configured to provide a data transmission channel between elements 121, 122, 124,125 and 126 of the controller 120. Such a bus 127 may include a control bus for transmitting various control signals, commands and etc., and a data bus for transmitting various data, for example.

Some of the elements 121, 122, 124 and 25, 126 of the controller 120 mentioned above may be deleted or some of them may be integrated as one. If necessary, one or more other elements, other than the above-mentioned elements of the controller 120, may be additionally provided.

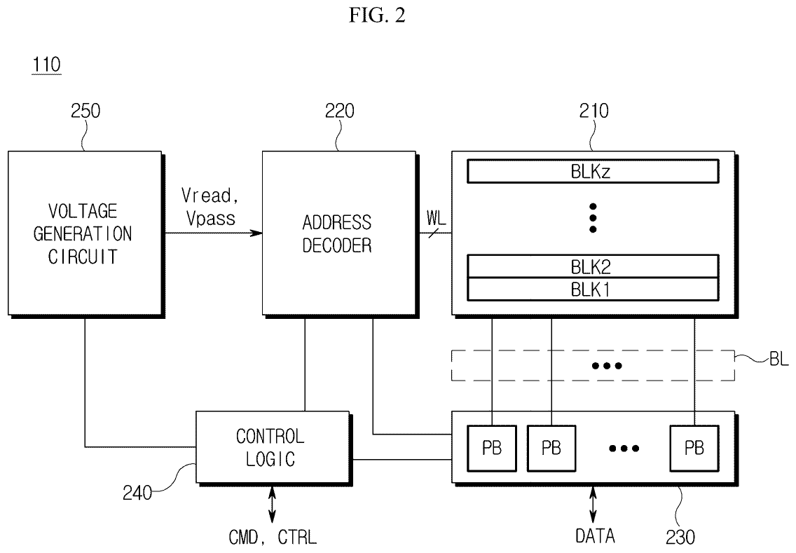

FIG. 2 is a block view schematically illustrating a memory according to embodiments of the present disclosure.

Referring to FIG. 2, a memory 110 according to embodiments of the present disclosure may include a memory cell array 210, an address decoder 220, a read and program circuit 230, a control logic 240, and a voltage generation circuit 250.

The memory cell array 210 may include a plurality of memory blocks BLK1 to BLKz (where z is a natural number that is equal to or greater than 2).

In the plurality of memory blocks BLK1 to BLKz, a plurality of word lines WL and a plurality of bit lines BL may be arranged and a plurality of memory cells MS may be arranged.

The plurality of memory blocks BLK1 to BLKz may be connected to the address decoder 220 via the plurality of word lines WL. The plurality of memory blocks BLK1 to BLKz may be connected to the read and program circuit 230 via the plurality of bit lines BL.

Each memory block BLK1 to BLKz may include a plurality of memory cells. For example, the plurality of memory cells may be nonvolatile memory cells, specifically, nonvolatile memory cells having a vertical channel structure.

The memory cell array 210 may be configured of a two-dimensional memory cell array, and in some cases, may be configured of a three-dimensional memory cell array.

Meanwhile, each of the plurality of memory cells provided in the memory cell array may store at least 1 bit data. As one example, each memory cell provided in the memory cell array 210 may be a single-level cell (SLC) storing 1 bit. As another example, each memory cell provided in the memory cell array 210 may be a multi-level cell (MLC) storing 2 bits, a triple-level cell (TLC) storing 3 bits or a quad-level cell (QLC) storing 4 bits. As a further example, the memory cell array 210 may include a plurality of memory cells storing 5 or more bits, respectively.

Referring to FIG. 2, the address decoder 220, the read and program circuit, the control logic 240 and the voltage generation circuit 250 may operate as peripheral circuits configured to drive the memory cell array 210.

The address decoder 220 may be connected to the memory cell array 210 via the plurality of word lines WL.

The address decoder 220 may be configured to operate in response to the control of the control logic 240.

The address decoder 220 may receive an address via an input/output buffer provided in the memory 110. The address decoder 220 may be configured to decode a block address among the received addresses. The address decoder 220 may select at least one memory block based on the decoded block address.

The address decoder 220 may receive an input of a read voltage Vread and a pass voltage Vpass from the voltage generation circuit 250.

When performing a read voltage application operation during a read operation, the address decoder 220 may apply a read voltage Vread to a selected word line WL inside the selected memory block and apply a pass voltage Vpass to the other non-selected word lines WL.

When performing a program verification operation, the address decoder 220 may apply a verification voltage generated in the voltage generation circuit 250 to the selected word line WL inside the selected memory block, and apply a pass voltage Vpass to the other non-selected work lines WL.

The address decoder 220 may be configured to decode a column address among the received addresses. The address decoder 220 may transmit the decoded column address to the read and program circuit 230.

A read operation and a program operation of the memory 110 may be performed in a page unit. The address received when requesting the read operation and the program operation may include one or more of a block address, a row address and a column address.

The address decoder 220 may select one memory block and one word line based on the block address and the row address. The column address may be decoded by the address decoder 220 and then provided to the read and program circuit 230.

The address decoder 220 may include one or more of a block decoder, a row decoder, a column decoder and an address buffer.

The read and program circuit 230 may include a plurality of page buffers PB. The read and program circuit 230 may operate a read circuit during the read operation, and operate a program circuit during the program operation.

The above-mentioned read and program circuit 230 may include a page buffer circuit having a plurality of page buffers PB referred to as Data Register Circuit.

The plurality of page buffers PB may be connected to the memory cell array 210 via a plurality of bit lines. While continuously supplying sensing current to the bit lines BL connected to the memory cells, the plurality of page buffers PB may detect changes in the amount of flowing current based on the program status of the corresponding memory cell and latch the changes as sensing data, in order to sense threshold voltages Vth of the memory cells during the read operation and the program verification operation.

The read and program circuit 230 may operate in response to page buffer control signals output from the control logic 240.

During the read operation, the read and program circuit 230 may sense data of the memory cell, temporarily store read data and then output data DATA to the input/output buffer of the memory 110. As an embodiment, the read and program circuit 230 may include a column selection circuit, in addition to the page buffers PB or page resistors.

The control logic 240 may be connected to the address decoder 220, the read and program circuit 230 and the voltage generation circuit 250. The control logic 240 may receive a command CMD and a control signal CTRL through the input/output buffer of the memory 110.

The control logic 240 may be configured to control overall operations of the memory 110 in response to the control signal CTRL. The control logic 240 may output a control signal for adjusting a pre-charge potential level of the sensing nodes of the plurality of page buffers PBs.

The control logic 240 may control the read and program circuit 230 to perform a read operation of the memory cell array 210. The voltage generation circuit 250 may generate a read voltage Vread and a pass voltage Vpass in response to a voltage generation circuit control signal output from the control logic 240 during the read operation.

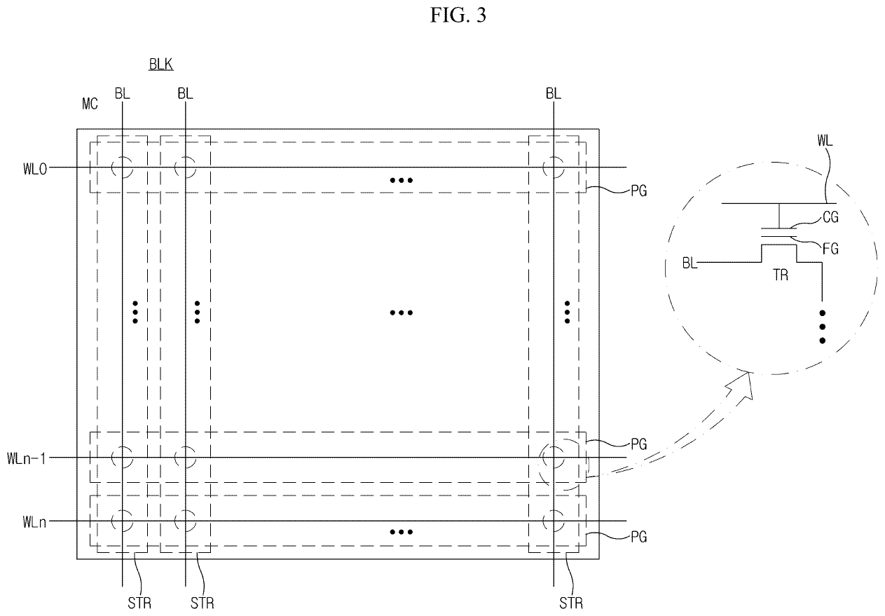

FIG. 3 is a view schematically illustrating a memory block of a memory according to embodiments of the present disclosure.

Referring to FIG. 3, an exemplary memory block BLK provided in a memory 110 may be disposed in each of positions where a plurality of pages and a plurality of strings STR intersect, for example.

The plurality of pages PG may correspond to the plurality of word lines WL, and the plurality of strings STR may correspond to the plurality of bit lines BL.

In the memory block BLK, the plurality of word lines WL and the plurality of bit lines BL are arranged to intersect each other. As one example, each of the word lines WL may be arranged in the row direction and each of the bit lines BL may be arranged in the column direction. As another example, each of the word lines WL may be arranged in the column direction and each of the bit lines BL may be arranged in the row direction.

A plurality of memory cells MC may be defined in the positions where the plurality of word lines WL and the plurality of bit lines BL intersect. A transistor TR may be disposed in each of the memory cells MC.

For example, the transistor TR disposed in each memory cell MC may include a drain, a source and a gate. The drain (or source) of the transistor TR may be connected to a corresponding bit line BL directly or via another transistor TR. The gate of the transistor TR may include a floating gate FG surrounded by an insulator and a control gate CG to which a gate voltage is applied from the word line WL.

In each of the memory blocks BLK1 to BLKz, a first selection line (referred to as a source selection line or a drain selection line) may be further arranged outside of the first outmost word line and closer to the read and program circuit 230 (from among the two outermost word lines), and a second selection line (also referred to as a drain selection line or source selection line) may be further arranged outside of the other second outermost word line.

In some cases, one or more dummy word lines may be further provided between the first outermost word line and the first selection line. In addition, one or more word lines may be further provided between the second outermost word line and the second selection line.

Read operations and program operations (i.e., write operation) may be performed in a page unit, and the erase operations may be performed in a memory block unit when the memory has memory blocks with the structure illustrated in FIG. 3.

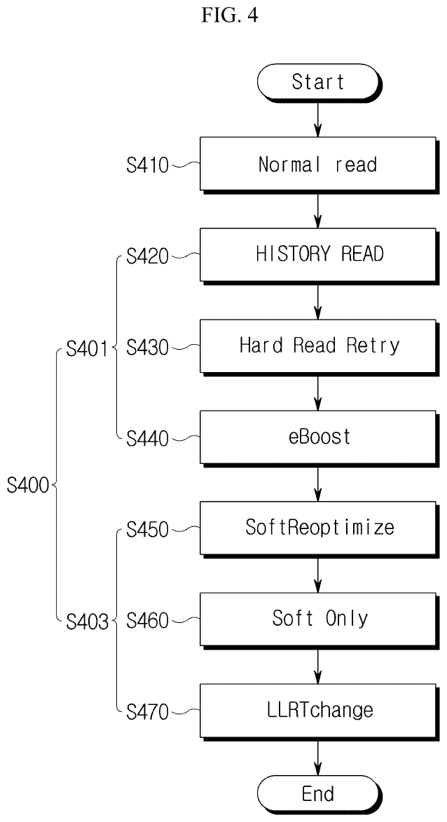

FIG. 4 describes a read recovery operation of a storage device according to embodiments of the present disclosure.

Referring to FIG. 4, a normal read operation S410 may be performed and after the normal read operation S410, a read recovery operation S400 may be performed.

With reference to FIG. 1 to FIG. 3 above, in the normal read operation S410, a controller 120 may provide a physical address indicating a cell location to a memory 110, where a read command and data to be read are stored, in response to a read command from an external device 150.

The memory 110 may provide read data stored at the received physical address to the controller 120, using a default read voltage. Here, the read voltage may be a voltage applied to identify data stored in the memory cell, and the default read voltage may be a read voltage determined through testing in the process of manufacturing the memory 110.

Accordingly, the memory 110 may apply a read voltage to a word line WL corresponding to a physical address to be read during the read operation, and determine the value of the information bit stored in each cell based on whether the result of comparison between the read voltage and a voltage charged in the memory cell is greater or less than the voltage charged in the memory cell.

In addition, during the read operation, the controller 120 may perform an error correction decoding operation for the data acquired from the memory 110. According to an embodiment, the error correction decoding operation may be performed by an error detection and correction circuit 126 provided in the controller 120.

The error correction decoding operation may be an operation for acquiring original data by correcting error bits provided in the read data. The error correction decoding operation may succeed or fail based on whether the number of error bits contained in the read data is equal to or less than the number of correctable error bits. If the number of error bits contained in the read data is equal to or less than the number of correctable error bits, then the error correction decoding may be successful. Conversely, if the number of error bits contained in the read data exceeds the number of correctable error bits, then the error correction decoding may fail. When the error correction decoding operation is successful, original data corresponding to the logical address commanded to be read by the external device 150 may be acquired. Accordingly, when the error correction decoding operation is successful, the read operation performed by the memory 110 may be successful. If the error correction decoding operation fails, then the controller 120 cannot acquire original data and the read operation performed by the memory 110 may be a failed operation.

If it is determined that the normal read operation S410 has failed, then the controller 120 may execute the read recovery operation S400, which may perform a plurality of recovery operations until original data is obtained. The plurality of recovery operations may be performed in a preset order. While FIG. 4 illustrates one embodiment, and the method provided in the read recovery operation S400 is not limited thereto and may not limited to the order shown in FIG. 4. As more complex recovery operations are performed, the possibility of obtaining original data may increase, but the number of operations or calculations to be performed by the controller 120 may also increase, which may increase overhead, and it may take longer time to recover the original data. Accordingly, according to an embodiment, the controller 120 may perform recovery operations in order from recovery operations with low complexity to recovery operations with high complexity. If the original data is obtained by one recovery operation, the other recovery operations may not need to be performed.

Referring to FIG. 4, the read recovery operation S400 may be categorized into a hard decoding operation S401 and a soft decoding operation S403. A hard decoding operation S401, which has low complexity and takes a short time to recover original data, may be performed before the soft decoding operation S403.

The hard decoding operation S401 may determine the value of each bit by performing decoding on information of each bit of data received from the memory 110. According to an embodiment, the hard decoding operation S401 may determine a read voltage and provide it to the memory 110, and form read data by using the value of each bit (0 or 1) determined by the memory 110 based on the read voltage. Error correction decoding operations may be performed for the read data and success or failure of the read operation may be determined.

According to an embodiment, the hard decoding operation S401 may include at least one of a history read operation S420, a hard read retry operation S430 and an eBoost operation S440.

The history read operation S420 may determine whether a first read voltage used in the previous read operation is present in a physical address that is the target of a read operation in the memory 110. If there a corresponding voltage exists, then the obtained first read voltage may be provided to the memory 110 to perform the read operation. The first read voltage may be different from a default read voltage provided during the normal read operation S410. If there is no history related to the read voltage used in the previous read, the history read operation may not be performed.

The hard read retry operation S430 may be an operation that pre-stores a plurality of read voltages based on prestored scenarios in a read retry table RRT, performs a read operation by selecting at least one of the read voltages stored in the read retry table RRT in response to a current scenario, and provides the voltage to the memory 110 when the previous read operation fails. According to an embodiment, the read retry table may include 50 read voltages RRT1 to RRT49. The controller 120 may select five read voltages (e.g., RRT2, RRT22, RRT0, RRT35 and RRT42), from among the 50 read voltages RRT0 to RRT49, and provide the selected five read voltages (e.g., RRT2, RRT22, RRT0, RRT35 and RRT42) to the memory 110, to perform the read operation. The number of the read voltages provided in the read retry table may not be limited 50, but instead may vary according to embodiments. Likewise, the number of the read voltages selected for the actual read is not limited to five and may vary in different embodiments.

In addition, the controller may provide the selected read voltages, and if the read operation is successful before all of the selected read voltages are used, then it may terminate the read recovery operation without providing the remaining read voltages.

The eBoost operation S440 may be an operation that controls the controller 120 to calculate an optimal read voltage and to provide that to the memory 110 to perform the read operation. Here, the optimal read voltage may be calculated by various methods. According to an embodiment, the optimal read voltage may be calculated based on Gaussian modeling. Alternatively, the optimal read voltage may be calculated based on the number of 0 or 1 included in the data read by using a plurality of read voltages.

In the soft decoding operation S403, the memory 110 may provide an analog value (i.e., digitalized analog), not a digital value, of 0 or 1 for each bit. According to an embodiment, instead of simply using one bit, multiple bits may be used to represent information on each bit. The soft decoding operation S403 may have stronger error correction capability than the hard decoding operation S401, but it may have higher complexity and consume a lot of memory in implementation. In addition, the soft decoding operation S403 may require a larger read delay time than the hard decoding operation S401. According to an embodiment, when 2 bits are used to express 1 bit of information, the memory 110 needs to perform sensing three times by changing the read voltage so as to generate 4 levels of information that can be expressed with 2 bits. As the number of bits used to express 1 bit increases, the number of sensing operations performed while changing the read voltage may increase.

According to an embodiment, the soft decoding operation S403 may perform sensing by using an additional read voltage based on the above-mentioned default read voltage or the optimal read voltage determined in the eBoost operation. Soft decoding based on a soft re-optimization operation S450, a simple soft operation S460, a log likelihood ratio LLR table change operation S470 may be performed according to a method of generating the additional read voltage.

Referring to FIG. 4, when read is successful in each operation in the hard decoding operation S401, it is determined that read is successful and subsequent operations may be terminated without needing to perform them. In addition, when read is successful after individual operations, the soft decoding operation S403 may determine that read has succeeded and subsequent operations may be terminated without performing them.

If read fails even after all individual operations of the soft decoding operation S403 have been completed, then the soft decoding operation S403 may determine that recovery has failed and terminate the read recovery operation S400. After that, it may determine that the memory cell corresponding to the physical address is an error cell and may stop further use of that memory cell.

As described above, the hard decoding operation can determine the read success or read failure in one single sensing based on the provided read voltage, thereby lowering complexity and shortening delay time. On the other hand, the soft decoding operation has to perform several sensings, thereby causing more complexity and more delay time.

The read operation for the memory 110 may be sequentially performed. Accordingly, when a plurality of read commands are received from the external device 150 and a read recovery operation is performed for the read command currently being processed, the other plurality of read commands waiting behind may experience a delay until the read recovery operation based on the read command currently being processed is completed. That is, due to read failure and recovery in the current read operation, the plurality of read commands waiting behind may experience significant delays, which might deteriorate the read performance of the storage device 100.

The present disclosure recognizes these disadvantages and proposes a method of terminating a read operation based on the importance of the data to be read without performing all of the read recovery operation S400 of FIG. 4, even if there are some errors. According to an embodiment of the present disclosure, all of the decoding operations shown in FIG. 4 may be performed for data with high importance, in which original data with no errors can be obtained. However, only predetermined decoding operations may be performed for data with low importance, or the decoding operations may be performed only until an error rate reaches a preset value or less, resulting in original data that may have an error.

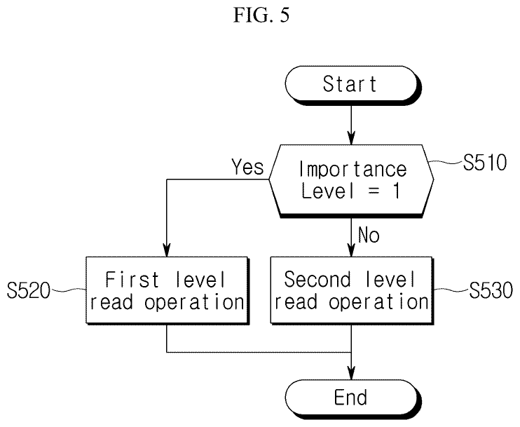

FIG. 5 is a flow chart illustrating a method of reading data according to an embodiment of the present disclosure.

Referring to FIG. 5, a controller 120 may determine the importance of data to be read in an operation S510. In the description below, importance may be divided into two levels, but levels of importance may not be limited thereto. Importance may be divided into three or more levels. According to an embodiment of the present disclosure, when importance is divided into two levels, one level with high importance may be referred to as 1, High (H) or a first level, and the other level with low importance may be referred to as 0, Low (L) or a second level.

The controller 120 may perform a first level read operation in an operation S520 when determining that importance is 1. The controller 120 may perform a second level read operation in an operation S530 when determining that importance is 0.

Here, a first level read operation may be a read operation that performs a read recovery operation until the operation succeeds or may be a read operation that performs all of the pre assigned read recovery operations. The second level read operation may be a read operation that stops read recovery operations at a predetermined point, even if the read is not successful. Accordingly, the controller 120 may obtain data without errors through the first level read operation, or may determine a read failure through the first level read operation. The controller 120 may obtain data that includes an error through a second level read operation, in which the controller 120 may determine that there is a read failure while reserving determination on the error.

According to an embodiment of the present disclosure, the controller 120 may perform a read operation until the read is successful according to the order shown in FIG. 4.

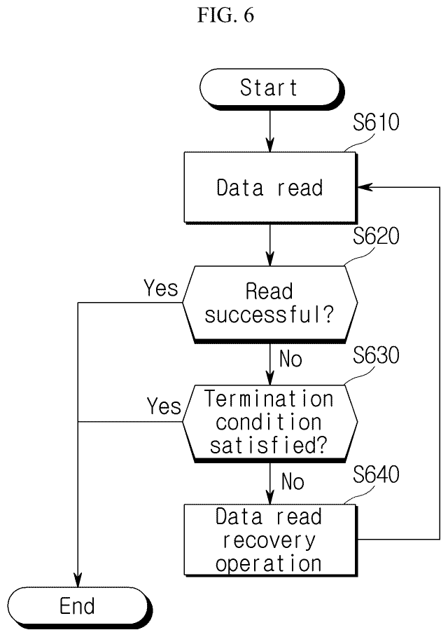

FIG. 6 is a view illustrating a second level read operation according to an embodiment of the present disclosure.

Referring to FIG. 6, a controller 120 may perform a normal read operation in an operation S610. The normal read operation may be the same as a normal read operation of operation S410 shown in FIG. 4.

In an operation S620, when determining that a read is successful and the read is successful with no errors, the controller 120 may terminate the second read operation. When determining that read is not successful, the controller 120 may determine whether a condition for a second level read operation termination is satisfied in an operation S630. According to an embodiment of the present disclosure, the second level read operation may be set to perform only the hard decoding operation as the read recovery operation. In this instance, in the operation S630, the controller 120 may determine that the termination condition is satisfied when all of the performable hard decoding operations are performed, and it may then terminate the second level read operation. According to another embodiment of the present disclosure, the second level read operation may be set to be terminated when the bit error rate is a preset value or less. In this instance, the second level read operation may only allow several read recovery operations for read recovery. For example, among the read recovery operations of FIG. 4, only the history read operation S420, the hard read retry operation S430 and the simple soft operation S460 may be set as the read recovery operation. In this instance, in an operation S630, the controller 120 may determine that the termination condition is satisfied once all of the preset read recovery operations are performed, and may terminate the second level read operation.

In the operation S630, the controller 120 may perform a data read recovery operation in the operation S640, when determining that the termination condition is not satisfied. According to an embodiment of the present disclosure, the controller 120 may perform the next data read recovery operation according to the order shown in FIG. 4, or may perform one of the preset read recovery operations when a read recovery operation to be read is preset.

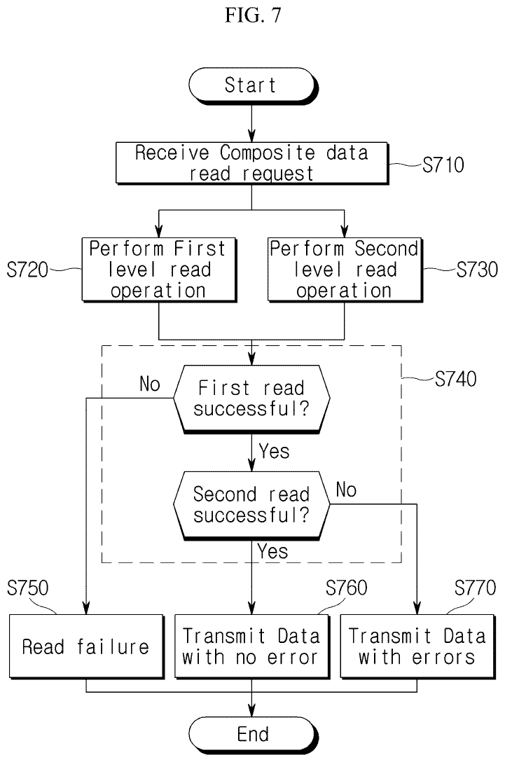

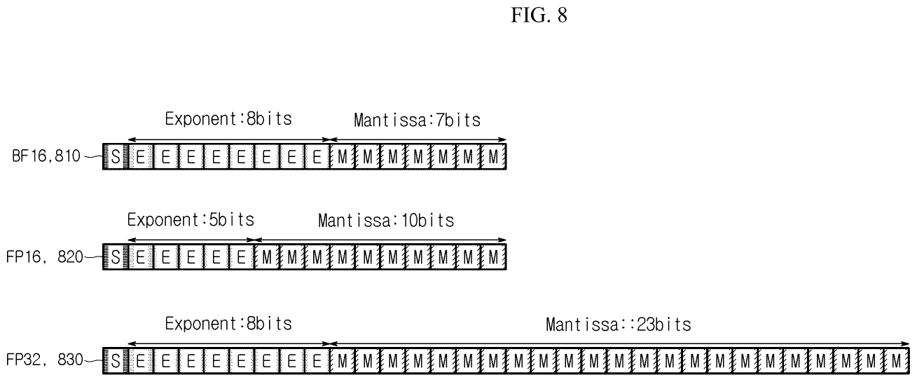

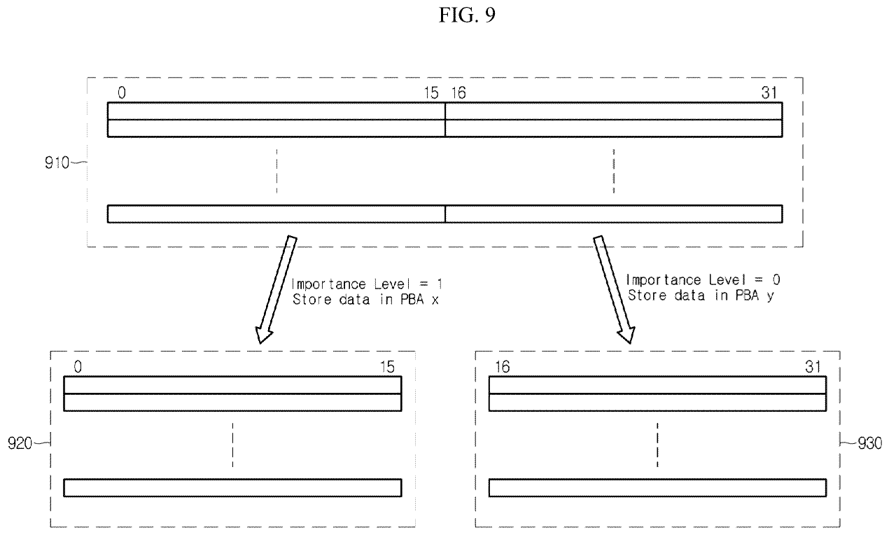

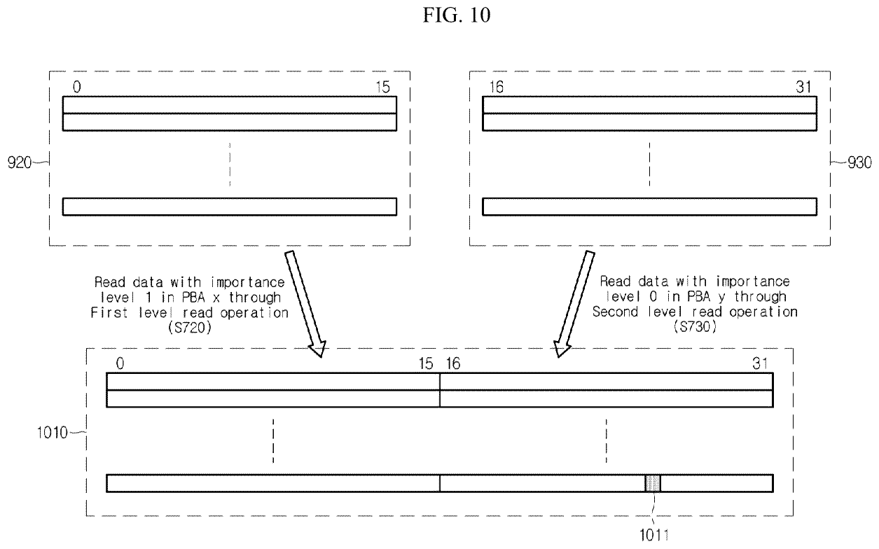

FIG. 7 is a view illustrating a first embodiment of performing a method of reading data based on importance according to embodiments of the present disclosure. FIG. 8 is a view illustrating various examples that express real numbers on a computer. FIG. 9 is a view illustrating an example of storing data in different physical block addresses based on importance. FIG. 10 is a view illustrating an example of reading data stored in different physical block addresses based on importance.

In a first embodiment, data may be divided into bits with high importance and bits with low importance. For example, a computer may use various formats as shown in FIG. 8 to represent flowing point numbers, and the upper few bits may be bits with high importance and the other bits may be bits with low importance.

In FIG. 8, BF16 (BFloat16) 810, FP16 (Half-Precision 16-bit Floating-Point) 820 or FP32 (Single-Precision 32-bit Floating-Point) 830 represents one floating point number in a computer. BF16 810 and FP16 820 may be 16 bits, and FP32 830 may be 32 bits. Here, BF16 810 has 1 sign bit (S), 8 exponent bits (E) and 7 mantissa bits (M). FP16 820 has 1 sign bit (S), 5 exponent bits (E) and 10 mantissa bits (M). FP32 830 has 1 sign bit (S), 8 exponent bits (E) and 23 mantissa bits (M).

Artificial intelligence must have a large number of parameters with real values, which may be stored in the memory using a format shown in FIG. 8. If 16 bits are used to represent a real value of a parameter, then the memory usage may be small but the precision may be low. Whereas, if 32 bits are used to represent a parameter value, then the memory usage may be large but the precision may be high. Therefore, when training an AI model, a real number may be expressed in the format of the FP32 820 to increase precision, which may improve the accuracy of a model. When making inferences by using the trained AI model, the calculation speed may be increased by using a 16-bit format of FP16 820 or BF16 810, and the memory usage may be reduced. Especially when comparing the FP32 830 and the BF16 810 with each other, BF16 810 may be the same as the upper 16 bit with high importance and may be a format not using the lower 16 bits with low importance. Accordingly, to speed up calculation, a mixed format may be often used in training an artificial model, and the format of the FP32 830 may be used to increase the precision and afterwards when using a trained artificial model, the format of the BF16 810 may be used. In an example, the upper 16 bits of the FP32 830 may have high importance but the lower 16 bits thereof may have low importance. Or, to further increase the precision, the upper 24 bits of the FP32 830 may be set to have high importance and the lower 8 bits thereof may be set to have low importance. Similarly, the upper 12 bits of the FP16 820 may be set to have high importance and the lower 4 bits thereof may be set to have low importance. Or, the upper 8 bits of the FP16 820 may be set to have high importance and the lower 8 bits thereof may be set to have low importance.

As described above, some bits of data may be set to have high importance of H (i.e., 1) and the other bits may be set to have low importance of L (i.e., 0). Information about bits with high importance and bits with low importance may be preset. In some cases, importance may be variable based on the settings of an external device 150 or updating of firmware. According to another embodiment, information about high-importance bits and low-importance bits may also be actively provided when the external device 150 transmits a data write command to a storage device 100. For example, when the external device 150 transmits data to the storage device 100 to store data, high-importance bits may be provided as a parameter.

Referring to FIG. 9, a controller 120 may receive a data write command from the external device 150, and when data is divided into high-importance bits and low-importance bits, it may store high-importance bits and low-importance bits in different memory blocks.

As shown in FIG. 9, when data has a 32-bit format, 16 bits from bit 0 to bit 15 are set as high-importance bits (importance=1) and 16 bits from bit 16 to bit 31 are set as low-importance bits (importance=0), the controller 120 may store a first bit unit 920 configured of only the 16 bits from bit 0 to bit 15 from received data 910 in a physical block address x (PBA x), and a second bit unit 930 configured of 16 bits from bit 16 to bit 31 in a physical block address y (PBA y).

According to an embodiment of the present disclosure, the controller 120 may change the format of the stored block memory based on importance. For example, high-importance data may be stored in a memory block configured of SLC type cells, and low-importance data may be stored in a memory block configured of MLC, TLC or QLC type cells.

When receiving a read command for the stored data as shown in FIG. 9, the controller 120 may read the data and respond to the request based on a reading method shown in FIG. 7.

Referring to FIG. 7, in an operation S710, the controller 120 may receive a composite data command from the external device 150. Here, composite data can collectively refer to data with both high-importance data and low-importance data.

Referring to FIGS. 7 and 10, in operations S720 and S730, the controller 120 may simultaneously or sequentially perform a first level read operation for data with 1-level importance and a second level read operation for data with 0-level importance, in response to the composite data read command.

After performing the first level read operation and the second level read operation, the controller 120 may obtain read success and read failure information for data that has been read for each read operation. In an operation S740, when determining that the first level read operation is failed, the controller 120 may perform an operation S750 and determine read fail. Once it has been determined that read is failed, the controller 120 may send a message notifying the read failure to the external device 150 or may take no action. When the controller takes no action, the external device 150 may recognize that the read is failed due to a timeout.

In an operation S740, if the first level read operation is successful and the second level read operation is successful or failed, the controller 120 generates data 1010 in which the data obtained by the first level read operation and the data obtained by the second level read operation are combined. The controller may transmit the data to the external device 150 as shown in FIG. 10. At this time, the controller 120 may transmit data with no error to the external device 150 when the second level read operation is successful, and when the second level read operation is failed, it may transmit data 1010, including some error bits 1011 as shown in an operation S770 and FIG. 10, to the external device.

In an embodiment of FIG. 10, when a second level read operation fails and low-importance data including an error is obtained, the controller 120 may combine the obtained data with high-importance data and transmit the combination as composite data. According to another embodiment, the controller 120 does not transmit low-importance data but transmits only high-importance data of 16 bits to the external device 150. According to a further embodiment, the controller 120 may transmit a preset value (e.g., 0 or 0xFFFF) instead of the obtained data, i.e., low-importance data with errors.

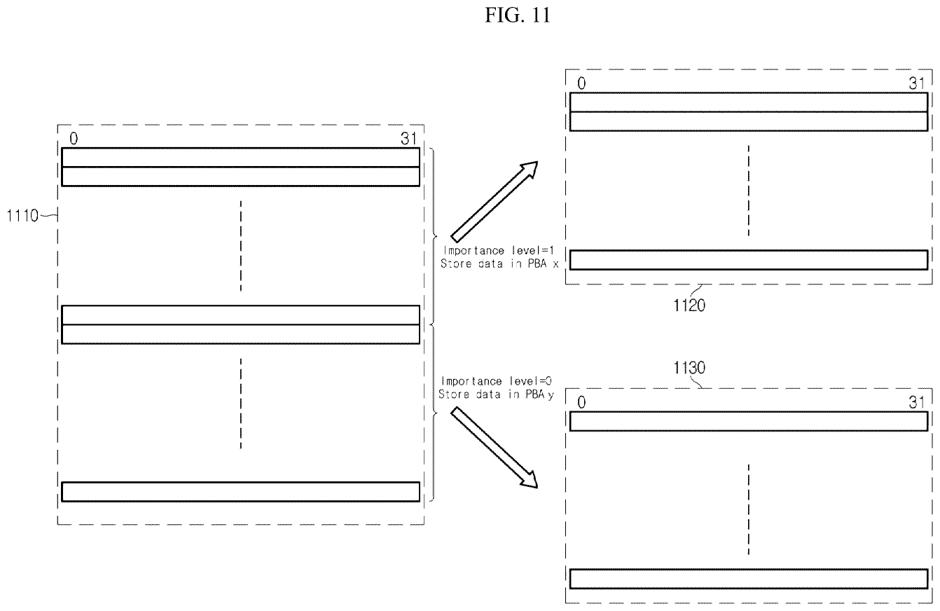

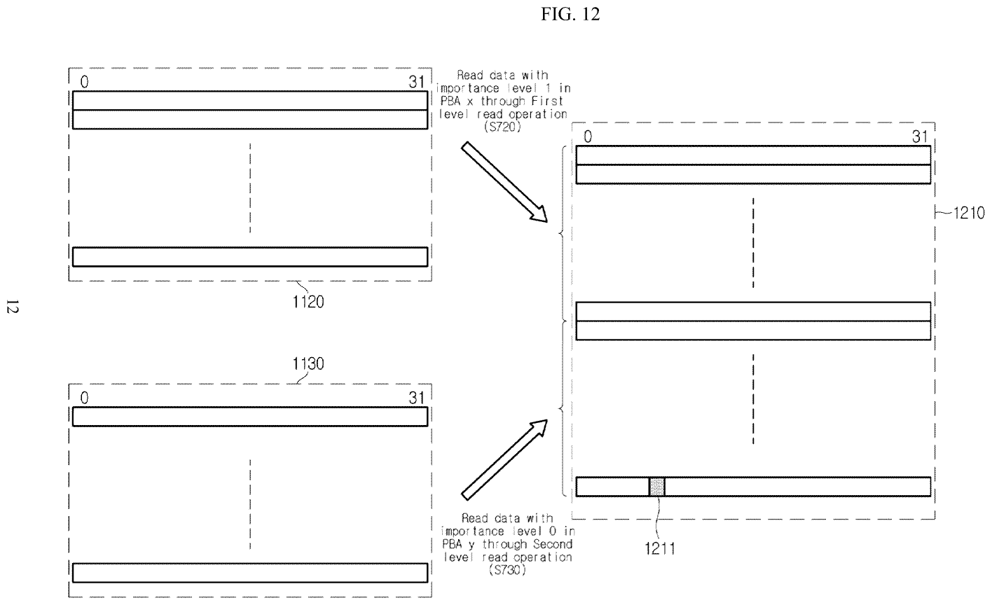

FIG. 11 is a view illustrating an example of storing data in different memory blocks based on importance according to various embodiments of the present disclosure. FIG. 12 is a view illustrating an example of reading data stored in different memory blocks based on importance according to various embodiments of the present disclosure.

As shown in FIG. 9, there may be data, such as real number expression data, that is divided into high-importance bits and low-importance bits. In contrast, as illustrated in an embodiment of FIG. 11, among the data to be read, some data may be configured of only high-importance bits and another some data may be configured of only low-importance bits. FIG. 9 illustrates the process of dividing and storing data according to the importance in a single block when the data processed by the controller includes data with different importance even in one block. On the other hand, FIG. 11 shows that when the importance of data stored in each block is the same, data blocks are divided and stored according to the importance of the included data.

For example, MPEG (Moving Picture Experts Group) compressed video data may include I (Intra) frames, P (Predicted) frames and B (Bi-directional) frames. The I frame may be a frame compressed by using only its current information, the P frame may be a frame compressed by using image information of a previous I or P frame, and the B frame may be a frame compressed by referencing previous and subsequent images and its own image. That is, information in the I frame may be used when compressing the P and B frames. Information in the P frame may be used when compressing the B frame. Accordingly, I frame data may have high importance and B frame data may have low importance.

MPEG compressed image data including I frame data, B frame data and P frame data may be stored in a memory 110.

Referring to FIG. 11, a controller 120 may store image data in a physical block address of the memory 110. According to an embodiment, the controller 120 may separate data blocks with high importance and data blocks with low importance from each other in the entire received data 1110, and may store them in different memory blocks. For example, the controller 120 may store a first data block with high importance (e.g., I frame data) 1120 in a physical block address x (PBA x), and a second data block with low importance (e.g., B frame data) 1130 in a physical block address y (PBA y). Here, the data block with high importance may be notified to the controller 120 by using a separate parameter when the external device 150 generates a data write command. According to another embodiment, when the controller receives known image data, the controller 120 may determine the frame structure of the image data, may extract I, P or B frame data and set importance for each frame data.

According to an embodiment, the controller 120 may vary the type of a physical block address to be stored based on importance. For example, the controller 120 may store high-importance data in a physical block address configured of SLC type cells and low-importance data in a physical address configured of MLC, TLC or QLC type cells.

When receiving a read command for the stored data as shown in FIG. 11, the controller may read the data based on the reading method shown in FIG. 7 and respond to the request.

Referring to FIG. 7, in an operation S710, the controller 120 may receive a composite data read command from an external device 150. Here, composite data may collectively refer to data in which high-importance data and low-importance data are combined.

Referring to FIGS. 7 and 12, in operations S720 and S730, the controller 120 may simultaneously or sequentially perform a first level read operation for data with level 1 importance and a second level read operation for data with level 0 importance, in response to the composite data read command.

After performing the first level read operation and the second level read operation, the controller 120 may obtain read success and read failure information, for data that has been read for each read operation. In an operation S740, when determining that the first level read operation is failed, the controller 120 may perform an operation S750 and determine that read is a failure. Once determining that read is failed, the controller 120 may send a message notifying the read failure to the external device 150 or the controller may take no action. When the controller takes no action, the external device 150 may recognize that the read is failed due to a timeout.

In an operation S740, if the first level read operation is successful and the second level read operation is successful or failed, the controller 120 may generate data 1210 in which the data obtained by the first level read operation and the data obtained by the second level read operation are combined, and transmit the data to the external device 150 as shown in FIG. 12. At this time, the controller 120 may transmit data with no errors to the external device 150 as shown in an operation S760 when the second level read operation is successful, and it may transmit data 1210 with some error bits 1211 to the external device when the second level read operation is failed, as illustrated by FIG. 12 and operation S770.

The above-noted embodiment proposes composite data in which the high importance data and the low importance data are combined. However, the controller 120 may receive a read command for data including only high-importance data or data including only low-importance data. In such instances, the controller 120 may perform the operations in FIG. 7, but it may skip the first level read operation or the second level read operation corresponding to high or low importance data respectively, if the high or low importance data is not included in the read request. For example, when receiving a read command for data including only low-importance data, the controller 120 may perform only the second level read operation and read the corresponding data.

In the above-noted embodiments, it is assumed and described that one external device 150 requests a data read or data write with importance information. However, a plurality of external devices 150 may be connected to the storage device 100 and importance of each external device 150 may be preset in the storage device 100. For example, a first external device and a second external device may be connected to the storage device 100. All data coming from the first external device may be set to have level 1 importance in the storage device 100, and all data coming from the second external device may be set to have level 0 importance in the storage device 100. Then, when receiving a read command from the first external device, the controller 120 of the storage device 100 may perform a read using the first level read operation only. When receiving a read command from the second external device, the controller may perform a read using the second level read operation only. In these examples, the external device does not transmit importance information together with a data read command to the storage device 100.

An external device according to a third embodiment may transmit a data read command for data with 1 importance or data with 0 importance, but not a composite data read command. Then, the controller 120 may perform the first level read operation of the operation S720 for the data read command for the data with 1 importance, which is the same as the read operation of the conventional art.

The controller 120 may perform the second level read operation of the operation S730 for a data read command for data with 0 importance. The second level read operation is the same as that of FIG. 6. When the preset termination condition is satisfied, the controller 120 does not further perform the data read recovery operation, even for the data having been read with an error, and may terminate the read operation. Furthermore, if the data has an error, the controller 120 may transmit resulting data obtained in the second level read operation to the external device 150 on an as-is basis. The controller may transmit data with no errors or an error failure message for a data read command for data with 1 importance. On the other hand, the controller may transmit data with no errors or data with errors in some bits for a data read command with 0 importance. The bits with errors may be recovered as original data in the external device 150, and even if used without correction, the impact on further results may be extremely small.

In the above-noted embodiments, the importance of requested data may be notified to the controller when the external device 150 transmits a data read command, or the importance of the data written by the external device 150 may be separately notified. The controller 120 may store information about the importance of data stored in each memory block or page. And, the controller may obtain importance information of data to be read when a read command is issued, and may perform a first level read operation and/or second level read operation based on the obtained importance.

According to an embodiment, the controller 120 may determine the importance of data stored in each memory block or page. For example, the controller 120 may set the importance of a memory block or page, in which OS (Operating System) data or metadata are written, to be 1 (i.e., high) and set importance of cold data, in which read is not performed a preset number of times during a preset time, to be 0 (i.e., low).

According to another embodiment, the controller 120 may set importance of preset memory blocks or pages even among the cold data to be 1 and importance of other blocks or pages to be 0. Data frames of image data, which are usually considered cold data, may include important parameters related to image data including a frame structure at the beginning of the frame. In addition, since the I frame is at the beginning of the video data, the beginning of the video data may be important. Accordingly, the controller 120 may set importance of first several memory blocks or pages to be 1.

According to another embodiment, the controller 120 may find cold data with very few reads during garbage collection and/or wear leveling, and perform an algorithm to extract a video frame for the cold data, to determine an I, B or P frame. Then, it may set importance of I frame to be 1 and importance of B frame to be 0. The controller 120 may move the 1 importance data or 0 importance data to different memory blocks or pages for storage.

In addition, in an operation of performing a read to move data during the garbage collection and/or wear leveling operation, the controller 120 may perform a first level read operation or a second level read operation based on the importance set in each memory block or page. The controller 120 may perform the read operation until the read succeeds during the first level read operation, but it may terminate a read operation during a second level read operation, but only if the preset termination condition is satisfied. In this instance, the controller may obtain only data with an error and may store it without alteration in a memory block or page, to which the data with an error will be moved.

As described above, in the present disclosure, different termination conditions may be set based on importance of data and the read for low importance data may be terminated under preset termination conditions, even if the recovered data has an error, thereby increasing the read speed and then improving read performance of the storage device.

The above disclosure and description assumed data with importance of two levels (1 and 0), but embodiments are not limited to two levels and the number of importance levels may be three or more. Also, different read termination conditions for respective importance levels may be preset to adjustably balance system performance and precision in various embodiments.

What is claimed is:

1. A memory controller comprising:
a first interface configured to perform data communication with a first external device;
a second interface configured to generate a signal configured to control an operation of a second external device; and
at least one processor configured to:
determine an importance level of data to be read from the second external device;
perform preset read recovery operations when a read operation fails, and
perform a first level read operation to recover data to be read with a high importance and perform a second level read operation to recover the data to be read with a low importance,
wherein the first level read operation terminates when high importance data to be read is obtained without errors or when the data to be read is determined as uncorrectable, and the second level read operation terminates when a preset termination condition is satisfied for low importance data.

2. The memory controller of claim 1, wherein
in the first level read operation, a first read recovery operation is performed when a first read operation fails to obtain the high importance data to be read without an error and terminates when the preset read recovery operations have been performed and fail to obtain the high importance data without an error, and
in the second level read operation, a second read recovery operation is performed when a second read operation fails to obtain the low importance data to be read without an error and terminates when the preset termination condition is satisfied or when the preset read recovery operations obtain the low importance data without an error.

3. The memory controller of claim 2, wherein the at least one processor is configured to:
set, for the first read recovery operation, at least one hard-decoding-based read recovery operation and at least one soft-decoding-based read recovery operation as the preset read recovery operations.

4. The memory controller of claim 3, wherein the at least one processor is configured to:
set, for the second read recovery operation, one or more preset read recovery operations that are set for the first read recovery operation; and
set, as the termination condition of the second read recovery operation, performance of the preset read recovery operations.

5. The memory controller of claim 3, wherein the at least one processor is configured to:
set, for the second read recovery operation, at least one hard-decoding-based read recovery operation as the preset read recovery operations; and
set, as the preset termination condition of the second read recovery operation, performance of the preset read recovery operations.

6. The memory controller of claim 3, wherein the at least one processor is configured to:
set, as the preset termination condition of the second read recovery operation, a bit error rate of the low importance data at a preset value or less.

7. The memory controller of claim 6, wherein the at least one processor is configured to:
set the preset read recovery operations of the second read recovery operation to be the same as the preset read recovery operations of the first read recovery operation.

8. The memory controller of claim 1, wherein the at least one processor is further configured to:
receive a read command for composite data comprising a first bit unit including bits with high importance and a second bit unit including bits with low importance from the first external device through the first interface;
perform the first level read operation to read the first bit unit of the composite data from the second external device through the second interface;
perform the second level read operation to read the second bit unit of the composite data from the second external device through the second interface; and
transmit a read failure message, requested composite data with no errors or requested composite data with an error to the first external device, based on whether the first level read operation for the first bit unit is successful and whether the second level read operation for the second bit unit is successful.

9. The memory controller of claim 8, wherein the at least one processor is configured to:
transmit the read failure message to the first external device when the first level read operation for the first bit unit is failed;
transmit composite data of the first bit unit and the second bit unit with no errors when both the first level read operation for the first bit unit and the second level read operation for the second bit unit are successful; and
transmit composite data of the first bit unit with no errors and the second bit unit with an error when the first level read operation for the first bit unit is successful and the second level read operation for the second bit unit is failed.

10. The memory controller of claim 9, wherein the at least one processor is configured to:
receive a write command for the composite data from the first external device;
write the first bit unit of the composite data in a first memory block of the second external device, and
write the second bit unit of the composite data in a second memory block of the second external device.

11. The memory controller of claim 10, wherein the at least one processor is configured to:
receive the write command including information about bits corresponding to the first bit unit and the second bit unit from the first external device, and
distinguish and extract the first bit unit and the second bit unit based on the information about bits corresponding to the first bit unit and the second bit unit.

12. The memory controller of claim 10, wherein the at least one processor is configured to:
preset information about bits corresponding to the first bit unit and bits corresponding to the second bit unit, and
distinguish and extract the first bit unit and the second bit unit based on the preset information.

13. The memory controller of claim 10, wherein a type of the first memory block and a type of the second memory block are different.

14. The memory controller of claim 8, wherein the at least one processor is configured to:
receive a read command for the first bit unit from the first external device;
transmit the read failure message to the first external device when the first level read operation for the first bit unit is failed; and
transmit the first bit unit to the first external device when the first level read operation for the first bit unit is successful.

15. The memory controller of claim 9, wherein the at least one processor is configured to:
transmit composite data of only the first bit unit, when the first level read operation for the first bit unit is successful and the second level read operation for the second bit unit is failed.

16. The memory controller of claim 1, wherein the at least one processor is configured to:
receive a read command for a first data block with high importance data and a second data block with low importance data from the first external device,
perform the first level read operation to read the first data block from the second external device,
perform the second level read operation to read the second data block from the second external device, and
transmit a read failure message, data with no errors or data with an error to the first external device, based on whether the first level read operation for the first data block is successful and whether the second level read operation for the second data block is successful.

17. The memory controller of claim 16, wherein the at least one processor is configured to:
transmit the read failure message to the first external device when the first level read operation for the first data block fails,
transmit data including the first data block with no errors and the second data block with no errors to the first external device when both the first level read operation for the first data block and the second level read operation for the second data block are successful, and
transmit data including the first data block with no errors and the second data block with an error when the first level read operation for the first data block is successful and the second level read operation for the second data block is failed.

18. The memory controller of claim 17, wherein the at least one processor is configured to:
receive a write command for the data from the first external device;
write the first data block of the data in a first memory block of the second external device; and
write the second data block of the data in a second memory block of the second external device.

19. The memory controller of claim 18, wherein the at least one processor is configured to:
receive the write command including importance information about the first data block and the second data block from the first external device, and
distinguish and extract the first data block and the second data block based on the importance information about the first data block and the second data block.

20. The memory controller of claim 1, wherein the at least one processor is configured to:
determine a frequency of a read operation for data that is read during a background operation, and
for the data that is read during the background operation, set a low importance level when the frequency of the read operation is a preset value or less and set a high importance level when the frequency of the read operation is more than the preset value.

21. An operation of a memory controller comprising:
determining an importance level of level 1 or level 2 for data to read from a memory;
performing, for data with importance level 1, a first level read operation configured to obtain data with no errors or determine that data without errors cannot be obtained by a first read recovery operation; and
performing, for data with importance level 2, a second level read operation configured to terminate a second read recovery operation when a preset termination condition is satisfied.

22. The operation of the memory controller of claim 21, wherein the first level read operation comprises,
a first read operation; and
when the first read operation fails, the first read recovery operation configured to perform preset read recovery operations and be terminated when successful or after performing the preset read recovery operations, and
wherein the second level read operation comprises,
a second read operation; and
when the second read operation fails, the second read recovery operation configured to perform preset read recovery operation and be terminated when successful or the preset termination condition is satisfied.

23. The operation of the memory controller of claim 22, wherein the preset read recovery operations of the first read recovery operation comprises at least one hard-decoding-based read recovery operation and at least one soft-decoding-based read recovery operation,
wherein the preset termination condition of the second read recovery operation is to perform the preset read recovery operations of the second read recovery operation, and
wherein the preset read recovery operation of the second read recovery operation is a part of the preset read recovery operations of the first read recovery operation.

24. The operation of the memory controller of claim 22, wherein the preset termination condition of the second read recovery operation is a bit error rate of read data is a preset value or less.

25. The operation of the memory controller of claim 21, further comprising:
receiving a read command for composite data comprising a first bit unit including bits with the importance level 1 and a second bit unit including bits with the importance level 2;
performing the first level read operation to read the first bit unit of the composite data;
performing the second level read operation to read the second bit unit of the composite data; and
transmitting a read failure message, composite data with no errors or composite data with an error, based on whether the first level read operation for the first bit unit is successful and whether the second level read operation for the second bit unit is successful.

26. The operation of the memory controller of claim 21, further comprising:
receiving a read command for data comprising a first data block including the data with the importance level 1 and a second data block including the data with the importance level 2;
reading the first data block by using the first level read operation;
reading the second data block by using the second level read operation; and
transmitting a read failure message, data with no errors or data with an error based on whether the first level read operation for the first data block is successful and whether the second level read operation for the second data block is successful.

27. The operation of the memory controller of claim 21, further comprising:
determining a frequency of a read operation for data that is read during a background operation; and
for the data that is read during the background operation, setting the importance level 2 when the frequency of the read operation is a preset value or less and setting the importance level 1 when the frequency of the read operation is more than the preset value.

28. A storage device comprising:
a memory configured to store data; and
a memory controller configured to receive a command from a first external device and control an operation of the memory based on the received command,
wherein the memory controller comprises,
a first interface configured to perform data communication with the first external device;
a second interface configured to generate signal configured to control an operation of the memory; and
at least one processor configured to:
determine an importance level of data to be read from the memory;
perform, for data with importance level 1, a first level read operation comprising a read operation and a read recovery operation and configured to obtain data with no errors or determine that the read operation is failed when data without errors cannot be obtained; and
perform, for data with importance level 2, a second level read operation comprising a read operation and a read recovery operation and configured to terminate a read recovery operation when a preset termination condition is satisfied.
